(19) United States
(12) Patent Application Publication
(10) Pub. No.: US 2005/0206223 A1
(43) Pub. Date: Sep. 22, 2005

(54) Connecting structure for wheel bearing and constant velocity joint

(75) Inventors: Jong Soon Im, Kangnam-gu (KR); Ji Hun Paek, Dongdaemun-gu (KR)

Correspondence Address: MICHAEL BEST & FRIEDRICH, LLP, 100 E WISCONSIN AVENUE, MILWAUKEE, WI, 53202, US

(73) Assignee: ILJIN BEARING CO., LTD., Gyeongsangbuk-do (KR)

(21) Appl. No.: 11/024,996

(22) Filed: Dec. 29, 2004

(30) Foreign Application Priority Data
Dec. 31, 2003 (KR) 10-2003-0101983

(51) Int. Cl. B60B 27/00

(52) U.S. Cl. 301/124.1

(57) ABSTRACT

The present invention is related to a connecting structure for a wheel bearing and a constant velocity joint which are connected and assembled by applying a plastic deformation of material using an orbital forming process or a swaging process. According to the present invention, the efficiency of assembly is improved and the length of a shaft is shortened compared with prior art to achieve a weight reduction. In the connecting structure, a coupling groove is formed on a hub of the wheel bearing, a recess is formed on a circumference of a shaft of the constant velocity joint, the shaft is inserted into the hub to be spline-connected with the hub, a circlip is inserted into the recess, the circlip is shrunk in the course of inserting the shaft into the hub, and the circlip is restored to former state by its elasticity and inserted into the coupling groove when the circlip is positioned on the groove.

### CROSS-REFERENCE TO RELATED APPLICATIONS

Priority is hereby claimed to South Korean patent application number KR 10-2003-0101983 filed on Dec. 31, 2003, the entire contents of which are incorporated herein by reference.

### TECHNICAL FIELD

The present invention relates to a connecting structure for a wheel bearing and a constant velocity joint, which achieves a weight reduction of parts and simplification of assembling, and increases productivity in assembling the wheel bearing and the constant velocity joint.

### BACKGROUND

Generally, a wheel bearing used in an axle of a vehicle makes a wheel rotate smoothly without friction loss, and functions to fix the wheel to a vehicle.

Wheel bearings have been gradually developed in order to reduce the number of manufacturing processes, to increase productivity and to make controlling of clearances easy. Wheel bearings presently on the market are third-generation wheel bearings.

With reference to FIG. 1, a cross-sectional view illustrating an assembled state of a wheel bearing unit 100 and a constant velocity joint 200 is shown.

First generation wheel bearings are characterized by a wheel bearing unit 100 formed as a double-row bearing 5, which has a outer race 4 integrated for supporting the assembled wheel bearing and constant velocity joint 200. Second generation wheel bearings are characterized by a bolt 1 engaged with a joint-shaft 9 and by integration and sharing of the outer race 4 and installation of a hub housing 3 having an inner race 3 at the same time. Third generation wheel bearings are characterized by the outer and inner races of a double-row bearing 5 serving as a hub by forming a flange not only on the outer race 4 of wheel bearing 100, but also on the inner race.

In order to increase the life span of the wheel bearing, a preload is applied between a bearing ball and an inner/outer race. In the first, second and third generations of wheel bearings, the preload is applied by adjusting a degree of engagement of a wheel bearing with a constant velocity joint. However, there were problems caused by the difficulty in controlling the degree of engagement and bolt looseness as time goes by. Thus, an advanced third generation of wheel bearings, which can uniformly apply the preload, is now in mass-production by applying a permanent plastic deformation to a material for the wheel bearing and assembling the wheel bearing using orbital forming and swaging.

As will be seen from FIG. 1, in connecting the first, second and third generations of wheel bearings with a constant velocity joint, the shaft 9 of the constant velocity joint 200 should be made sufficiently long to pass through a hub of the wheel bearing and has been connected to the hub by engaging the bolt 1 with an end of the shaft 9 protruding from the hub when inserting the shaft 9 of the constant velocity joint 200 into the hub for assembling. In such a construction, unnecessary time consumption occurs when assembling the constant velocity joint 200 and the wheel bearing 100. Furthermore, since the shaft 9 of the constant velocity joint 200 should be made sufficiently long to pass through a hub of the wheel bearing, the requirement for weight reduction of the wheel bearing unit 100 cannot be achieved. In cases where the wheel bearing is assembled by using orbital forming and swaging, as the preload is already applied in order to increase the endurance life time, there is not a need for connecting the wheel bearing and the constant velocity joint by bolting, and an improvement is needed.

### SUMMARY

Therefore, an object of the present invention is to solve the problems involved in the prior art, and to provide a connecting structure for a wheel bearing and a constant velocity joint in which, in connecting and assembling the wheel bearing assembled and the constant velocity joint by orbital forming or swaging, a shaft of the constant velocity joint and the wheel bearing are connected by a circlip positioned respectively in a coupling groove formed on an inner circumference of a hub of the wheel bearing and in a recess of a circumference of the shaft of the constant velocity joint.

In order to achieve the above object, there is provided a wheel bearing unit connected and assembled by orbital forming and swaging, the wheel bearing unit comprising:

a coupling groove being formed on an inner circumference of a hub of a wheel bearing and a recess being formed on a circumference of a shaft of a constant velocity joint; and a circlip inserted into the recess, the circlip being shrunk in course of inserting the shaft into the hub and restored to the former state by its elasticity and inserted into the coupling groove when the circlip is positioned on the groove.

According to the present invention, as the circlip is inserted into the recess and the groove when assembling the constant velocity joint and the wheel bearing, the length of the shaft of the constant velocity joint is shorter than that of the prior art and the efficiency of assembling is improved. Further, cost also is reduced due to the reduction of the length of the shaft and the assembly processes.

### BRIEF DESCRIPTION OF THE DRAWINGS

The above objects, and other features and advantages of the present invention will become more apparent by describing the preferred embodiment thereof with reference to the accompanying drawings, in which:

FIG. 1 is a cross-sectional view of a prior connecting structure for a wheel bearing and a constant velocity joint assembled by using orbital forming or swaging,

FIG. 2 is an enlarged perspective view of a shaft of a constant velocity joint according to the present invention,

FIG. 3 is a cross-sectional view of an assembled constant velocity joint 200 and wheel bearing 100 according to the present invention,

FIG. 4 is a cross-sectional view of a wheel bearing and a constant velocity joint before assembling, according to the present invention, and

FIG. 5 is a cross-sectional view of a constant velocity joint according to the present invention.

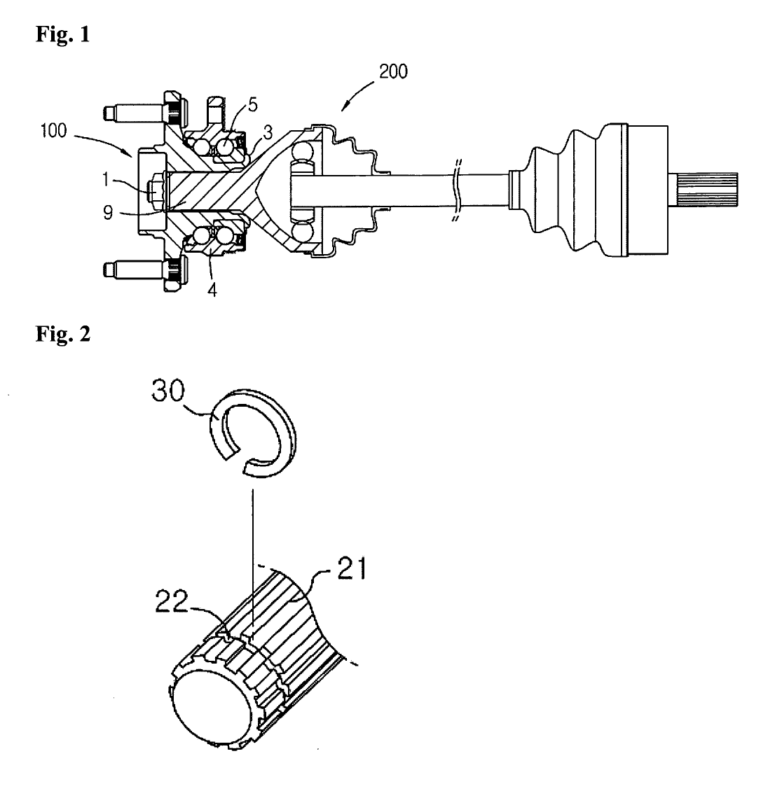

### DETAILED DESCRIPTION

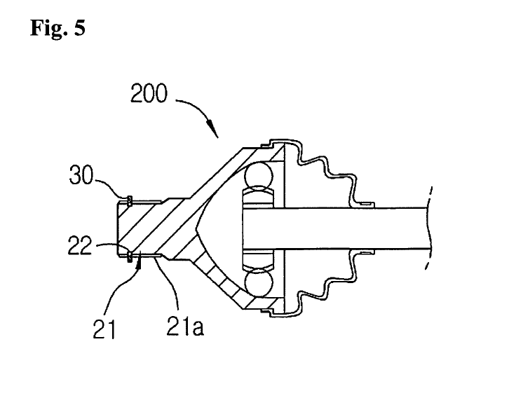

Reference will now be made in detail to a connecting structure for a wheel bearing and a constant velocity joint of the present invention by using the accompanying FIG. 2-FIG. 5.

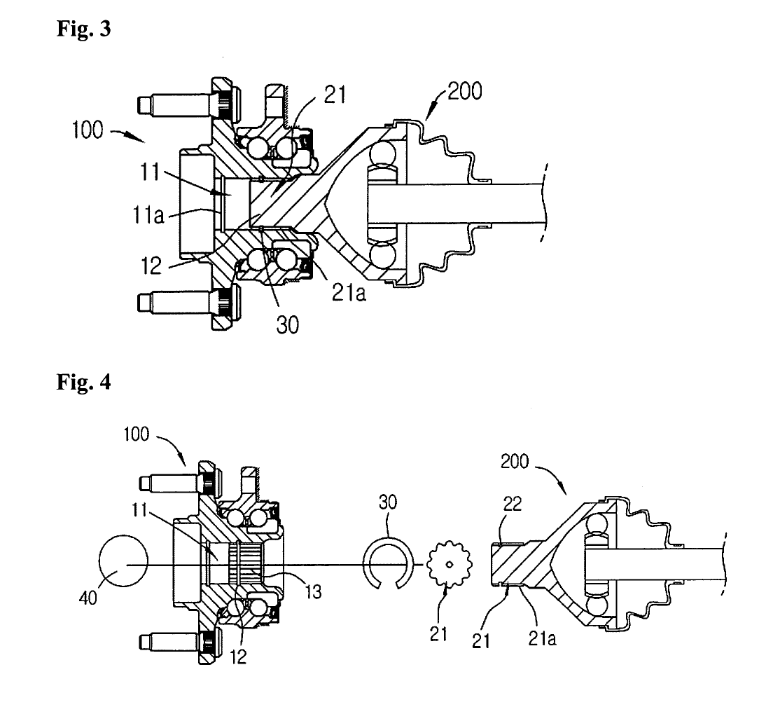

As will be seen from FIG. 2-FIG. 5, FIG. 2 is an enlarged perspective view of a shaft of a constant velocity joint according to the present invention, FIG. 3 is a cross-sectional view of an assembled constant velocity joint 200 and wheel bearing 100, and Fig. 4 is a cross-sectional view of a wheel bearing and constant velocity joint before assembly.

As shown in FIGS. 2-4, a spline 13 is formed on a wheel-bearing hub 11 along an axis of the hub 11.

A coupling groove 12 is formed on the spline perpendicular to the direction of the spline 13.

A corresponding spline 21a, which engages the spline 13 of the wheel-bearing hub 11, is formed on a circumference of a shaft 21 of the constant velocity joint 200. Therefore, when inserting the shaft 21 of the constant velocity joint 200 into the wheel-bearing hub 11 and connecting them, the two splines are engaged with each other and a driving force is transferred from the constant velocity joint 200 to the wheel bearing 100.

In order to prevent the shaft 21 inserted into the hub 11 from being detached from the hub11, a recess 22 is formed on the circumference of the shaft 21 and a circlip 30 is fixed into the recess 22. Then, the shaft 21 is inserted into the hub 11.

When the shaft 21 is inserted into the hub 11, the circlip 30 is shrunk by the inner surface of the hub 11.

In the course of inserting the circlip 30 into the hub 11, when the circlip 30 is positioned in the coupling groove 12, the shrunk circlip 30 is restored to its former state by its elasticity. Thus, the circlip 30 is tightly fixed into the coupling groovel2.

As will be seen from FIG. 3, the circlip 30 is positioned in the recess 22 of the shaft 21 and in the coupling groove 12 at the same time to substantially fix the shaft 21 against forward and backward movement.

Therefore, since the shaft 21 of the constant velocity joint 200 does not protrude out of the hub 11 of the wheel bearing 100 and is coupled in the hub 11, the length of the shaft 21 is shorter than the prior art to achieve a weight reduction. Also, the wheel bearing 100 and the constant velocity joint 200 are coupled by the circlip 30 to increase efficiency of assembly.

Since the spline 13 is not formed on the full inner circumference of the hub 11 in which the shaft 20 is inserted, but instead is only located in part of the hub 11, the efficiency of working can be increased.

As described above, when the wheel bearing 100 and the constant velocity joint 200 are coupled with each other by the circlip 30, the wheel bearing 100 and the constant velocity joint 200 are hardly separated from each other. As the wheel bearing and the constant velocity joint are firmly connected by the circlip 30, the problem in which the wheel bearing and the joint become disassembled does not occur.

Furthermore, a protection cap 40 is coupled with a groove 11a formed on a circumference of the entrance of the hub 11 in order to protect the hub 11 against the introduction of foreign materials.

As described above, when engaging the wheel bearing 100 in which the wheel bearing hub 11 and the inner race of the bearing are connected with each other by the plastic deformation of material, such as orbital forming and swaging, with the constant velocity joint 200, the process for roll forming and broaching is reduced and the rolling process for a screw is omitted due to the reduction of the length of the spline, thereby reducing cost. As the length of the shaft is reduced, weight reduction is achieved, resulting in improved fuel-efficiency of a car using the present invention.

1. A connecting structure for a wheel bearing and a constant velocity joint connected and assembled by applying a plastic deformation of a material using an orbital forming process or a swaging process, the connecting structure comprising:
a coupling groove formed on a hub of the wheel bearing; a recess formed on a circumference of a shaft of the constant velocity joint, said shaft being inserted into the hub to be connected with the hub by a spline; and a circlip inserted into the recess, said circlip being shrunk in the course of inserting the shaft into the hub, and said circlip being restored to a former state by its elasticity and inserted into the coupling groove when the circlip is positioned on the groove, whereby the circlip is positioned in the groove and the recess.

2. The connecting structure as claimed in claim 1, further comprising a protection cap, said protection cap being coupled with a second groove formed on a circumference of an entrance of the hub to protect the hub against introduction of foreign materials.

3. The connecting structure as claimed in claim 1, wherein the shaft of the constant velocity joint is connected in the hub of the wheel bearing to connect the wheel bearing with the constant velocity joint, and wherein the shaft extends less than fully through the hub.

4. The connecting structure as claimed in claim 1, wherein the spline is partly formed on the hub of the wheel bearing.
